(19) United States
(12) Patent Application Publication
(10) Pub. No.: US 2025/0348267 A1
(43) Pub. Date: Nov. 13, 2025

(54) MACHINE LEARNING BASED VOICE CONTROL FOR AUDIO DEVICE

(71) Applicant: Bose Corporation, Framingham, MA (US)

(72) Inventors: Thomas David Chambers, Bellingham, MA (US); Cameron Edward Hudson, Waltham, MA (US); Jonathan Robert Grovesteen, Mason, NH (US)

(21) Appl. No.: 18/661,893

(22) Filed: May 13, 2024

(51) Int. Cl. G06F 3/16; G06F 3/01

(52) U.S. Cl. CPC G06F 3/16; G06F 3/016

(57) ABSTRACT

Various implementations include approaches for voice control in audio devices. In some cases, a method includes: listening, using at least one audio capture device, for user input to control at least one attribute of an audio device; routing the user input through a machine learning (ML) model to determine a control action for the at least one attribute based on the user input; and causing the determined control action to be performed, wherein the ML model need not have been pre-trained with the user input to determine the control action for the at least one attribute of the audio device.

### TECHNICAL FIELD

This disclosure generally relates to audio devices and control functions. More particularly, the disclosure relates to voice control for audio devices relying on a machine learning (ML) model.

### BACKGROUND

Conventional audio device interfaces can present challenges for many users. For example, controlling headphones and/or speakers using on-product buttons can be limiting, while controlling such devices with mobile applications can be overwhelming or unnecessarily complicated. Further, control via voice assistant can be inefficient and frustrating for certain users.

### SUMMARY

All examples and features mentioned below can be combined in any technically possible way.

Various implementations include approaches for voice control in audio devices, and related devices. In some cases, a method includes: listening, using at least one audio capture device, for user input to control at least one attribute of an audio device; routing the user input through a machine learning (ML) model to determine a control action for the at least one attribute based on the user input; and causing the determined control action to be performed, wherein the ML model need not have been pre-trained with the user input to determine the control action for the at least one attribute of the audio device.

In additional particular aspects, an audio device includes: an electro-acoustic transducer; at least one microphone; and a processor coupled with the electro-acoustic transducer and the at least one microphone, the processor programmed to: listen, using the at least one microphone, for user input to control at least one attribute of the audio device; rout the user input through a machine learning (ML) model to determine a control action for the at least one attribute based on the user input; and cause the determined control action to be performed, wherein the ML model need not have been pre-trained with the user input to determine the control action for the at least one attribute of the audio device.

Implementations may include one of the following features, or any combination thereof.

In some cases, the audio device is separate from the audio capture device.

In certain implementations, the audio device and the audio capture device are commonly housed, for example, as a single device.

In certain cases, a control action can include at least one of a change in the attribute or maintaining the attribute.

In particular cases, the audio capture device performs the listening without requiring a wake word.

In additional implementations, the audio capture device detects a wake word prior to receiving the user input.

In some aspects, the audio capture device performs the listening after detecting a user command. In some cases, the user command includes at least one of a wake word, a button press or a user interface actuation.

In particular implementations, determining the control action includes selecting the at least one attribute of the audio device based on inferred intent from the user input.

In certain cases, the inferred intent is determined based on a nested selection approach.

In some aspects, the nested selection approach includes, applying a local portion of the ML model run on the at least one audio capture device or the audio device to determine the control action, and if the at least one attribute of the audio device is not selected by applying the local portion of the ML model, applying an off-device portion of the ML model to determine the control action.

In particular implementations, the off-device portion of the ML model is run on a smart device other than the audio capture device and/or a cloud-based or network-based system.

In certain cases, the nested selection approach includes evaluating the inferred intent relative to control functions of the audio device prior to control functions of a service utilized by the audio device.

In some examples, the control functions include on-device functions or grouping functions. In certain aspects, the service includes an audio streaming service or an internet radio service.

In particular aspects, control functions of the audio device enable control of at least one of, transport control, volume, active noise reduction (ANR), audio device grouping, equalization, spatial audio controls (e.g., motion versus still), transparency mode, or channel playback (e.g., stereo, left/right, coordinating channels with another speaker, and/or party mode). In further aspects, control functions of the service utilized by the audio device enable control of at least one of, a song or a track, an artist, a playlist, or a content channel.

In certain cases, a method further includes providing an audible response to the user input after determining the control action.

In some aspects, the audible response includes a natural language response including a query for an additional user input. In certain examples, the query includes a natural language based conversational response, such as from a virtual personal assistant, chatbot, or large language model.

In certain aspects, the user input relates to controlling one or more attributes of a plurality of audio devices including the audio device. In some examples, the attributes include coordinating playback, volume level, channel selection, or grouping.

In some cases, the method further includes providing a set of controllable attributes for the audio device to the ML model. In certain cases, the controllable attributes are defined in terms of an application programming interface (API). In some examples, the user input is compared to the controllable attributes, for example, a controllable attribute group. In certain aspects, if the user input matches a controllable attribute group, a positive response is provided with an audible response related to the control action. In further examples, if no match exists for any controllable attribute group, a null or negative response is provided. In certain cases, the null response is used to determine which controllable attribute is desired to be modified. For example, by separating controllable attribute groups into segments, the accuracy of the response can be improved.

In particular cases, the set of controllable attributes is provided to the ML model prior to the listening.

In certain aspects, the set of controllable attributes for the audio device is provided to the ML model with the user input.

In some implementations, the method further includes providing a set of audio device context data to the ML model for use in determining the control action for the at least one attribute. In some cases, the audio device context data can include: usage data, device state data (e.g., on, outputting audio, sleep mode, listening mode, paired with X, etc.), data about the known or likely user (e.g., based on proximity of user device such as smart phone), user profile data, data about location of the audio device (e.g., in the kitchen), data about the type of audio device (e.g., soundbar v. portable audio device v. wearable audio device), time of day, prior and/or last-paired device data, etc. In certain examples, context data can be provided with the user input, or ahead of time.

In particular aspects, routing the user input through the ML model includes defining a format of a response from the ML model including the control action. In one example, the format includes an object-based format such as JSON.

In certain aspects, the ML model is run on the at least one audio capture device or the audio device.

In particular implementations, the ML model includes a function-limited operational mode, and in response to detecting a threshold latency in network communication, the method includes running the ML model in the function-limited operational mode on the at least one audio capture device or the audio device. In some cases, the ML model is cloud-based.

In certain aspects, the ML model includes at least one of, a large language model (LLM) or a large action model (LAM).

Two or more features described in this disclosure, including those described in this summary section, may be combined to form implementations not specifically described herein.

The details of one or more implementations are set forth in the accompanying drawings and the description below. Other features, objects and advantages will be apparent from the description and drawings, and from the claims.

### BRIEF DESCRIPTION OF THE DRAWINGS

FIG. 1 is a block diagram of a system including at least one audio device, according to various disclosed implementations.

FIG. 2 is schematic data flow diagram illustrating processes in executing control actions based on user inputs according to various implementations.

FIG. 3 is a flow diagram illustrating processes in a method of controlling an audio device according to various implementations.

It is noted that the drawings of the various implementations are not necessarily to scale. The drawings are intended to depict only typical aspects of the disclosure, and therefore should not be considered as limiting the scope of the implementations. In the drawings, like numbering represents like elements between the drawings.

### DETAILED DESCRIPTION

This disclosure is based, at least in part, on the realization that voice-based audio device controls can benefit from use of a machine learning (ML) model. In particular cases, the ML model need not have been pre-trained with user input to determine a control action for at least one audio device attribute.

As noted herein, conventional audio device user interfaces can present challenges for many users. For example, controlling headphones and/or speakers using on-product buttons can be limiting, while controlling such devices with mobile applications can be overwhelming or unnecessarily complicated. Further control via voice assistant can be inefficient and frustrating for certain users.

In contrast to conventional approaches and systems, various implementations include approaches and systems for controlling audio devices using voice commands and a machine learning (ML) model. In particular cases, user input detected at an audio capture device is routed through an ML model to determine a control action for at least one attribute of the audio device, and based on processing by the ML model, the control action is performed. In various examples, the ML model needs not be pre-trained with the user input to determine the control action for the attribute.

Commonly labeled components in the FIGURES are considered to be substantially equivalent components for the purposes of illustration, and redundant discussion of those components is omitted for clarity. Various features of portable speakers, headsets, and voice controls are described herein, however, additional features of such speakers may be relevant to the disclosed implementations. Such additional features can be described in U.S. patents application Ser. No. 18/835,997 (“Dynamic Portable Speaker Grouping,” filed Nov. 1, 2023), and Ser. No. 18/387,144 (“Audio System Control Device,” filed Nov. 6, 2023), and U.S. Pat. No. 11,521,643 (“Wearable Audio Device with User Own-Voice Recording,” issued Dec. 6, 2022), U.S. Pat. No. 10,657,965 (“Conversational Audio Assistant,” issued May 19, 2020), U.S. Pat. No. 10,721,560 (“Intelligent Beam Steering in Microphone Array,” issued Jul. 21, 2020), and U.S. Pat. No. 10,580,430 (“Noise Reduction Using Machine Learning,” issued Mar. 3, 2020), each of which is incorporated by reference in its entirety.

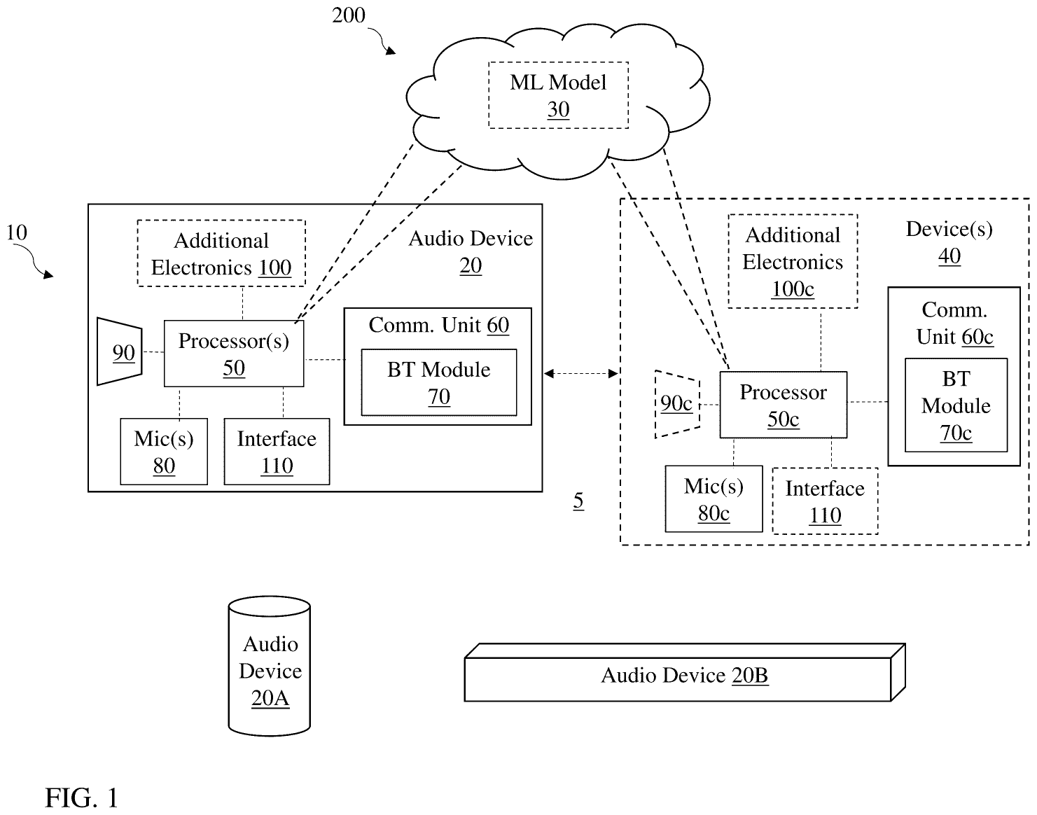

FIG. 1 shows an example of an environment (or, space) 5 including a system 10 with a set of devices according to various implementations. In various implementations, the system 10 is shown including one or more audio devices 20 configured to provide an audio output, e.g., to space 5. In some examples, not depicted, a plurality of audio devices can be located in space 5. As described herein, in various implementations the audio device 20 can include a speaker or a wearable audio device such as a set of headphones or body-worn speakers. In certain implementations, the audio device 20 includes a wearable audio device such as banded, wired, or wireless headphones, which can include occluding or non-occluding wearable headphones. In certain examples, the audio device 20 includes a fixed or portable speaker. In certain cases, a portable speaker includes a portable loudspeaker such as a portable smart speaker, a portable home speaker, or a portable public address (PA) system. In certain cases, one or more audio devices 20 is configured to facilitate voice control using a machine learning (ML) model 30. As described herein, the ML model 30 can be run (operated and/or stored) locally at the audio device 20 and/or at another device 40 in the space 5. In additional cases, the ML model 30 is run (e.g., operated and/or stored) in a remote or distributed computing system such as a network or cloud-based platform. In certain aspects, the system 10 is located in or around space 5, e.g., an enclosed or partially enclosed room in a home, office, theater, sporting or entertainment venue, religious venue, etc. In some cases, the space 5 has one or more walls and a ceiling. In other cases, the space 5 includes an open-air venue that lacks walls and/or a ceiling.

In one example implementation, another device 40 such as a smart device can be located in the space 5 and can be configured to communicate with the audio device 20 according to various implementations. In certain examples, device 40 can include a communications device, an audio gateway device, a computing device, etc. In various implementations, device 40 is a personal electronic device such as a smart phone, smart watch, or tablet computing device.

In certain cases, the audio device 20 is capable of being connected with device 40 and/or another device such as an additional audio device 20, a charging hub, an amplifier, a home entertainment system, etc. Two or more devices (e.g., audio device 20 and device 40) can communicate with one another using any communications protocol or approach described herein.

One or more of the audio devices 20 can include a portable speaker, such as a portable home speaker. It is understood that a “portable speaker” or a “portable home speaker” as described herein can refer to any of a number of speakers that are configured for wired and/or wireless operation, and are configured to change location. In certain cases, such speakers are labeled as “portable,” but this is not necessary in all implementations. Further, portable speakers and portable home speakers can be configured to charge in a dock, wirelessly charge, and/or remain connected to an external power source such as an outlet or additional device while outputting audio. Non-limiting examples of portable speakers provided by Bose Corporation (Framingham, MA, USA) can include the Bose Portable Smart Speaker, the Bose SoundLink Flex, the Bose SoundLink Micro, the Bose SoundLink Mini II, and/or the Bose SoundLink Revolve II (product names truncated for brevity). One or more audio devices described herein may be described as “fixed,” meaning that the audio device is designed to output audio in a static location or is configured to be mounted or otherwise fixed in a location. Certain examples of fixed speakers include wall or ceiling-mounted speakers, recessed speakers, speakers that form part of a surround sound unit in a home or other room entertainment system, and/or fixed speakers in a conference room, office, indoor/outdoor space, etc.

In certain cases, the audio device 20 includes one or more processors (or, controllers) 50 and a communication (comm.) unit 60 coupled with the controller 50. In certain examples, the communication unit 60 includes a Bluetooth module 70 (e.g., including a Bluetooth radio), enabling communication with other devices over Bluetooth protocol. In addition to processor(s) 50, the audio device 20 can also include one or more microphones 80 (e.g., a microphone array), and a transducer 90 (e.g., an electro-acoustic transducer) for providing an audio output, e.g., in space 5. Further, the audio device 20, can also include additional electronics 100, such as a power manager and/or power source (e.g., battery or power connector), memory, sensors (e.g., IMUs, accelerometers/gyroscope/magnetometers, optical sensors, voice activity detection systems), etc. In some cases, the memory may include a flash memory and/or non-volatile random access memory (NVRAM). Certain of the above-noted components depicted in FIG. 1 are optional, and are displayed in phantom.

In certain cases, the processor(s) 50 can include one or more microcontrollers or processors having a digital signal processor (DSP). In some cases, the processor(s) 50 are referred to as processing circuit(s) or control circuit(s). The processor(s) 50 may be implemented as a chipset of chips that include separate and multiple analog and digital processors.

The communication unit 60 can include the BT module 70 configured to employ a wireless communication protocol such as Bluetooth, along with additional network interface(s) such as those employing one or more additional wireless communication protocols such as IEEE 802.11, Bluetooth Low Energy, or other local area network (LAN) or personal area network (PAN) protocols such as Wi-Fi. In particular implementations, communication unit 60 is particularly suited to communicate with other communication units 60 in audio devices 20 and/or additional device(s) such as smart devices (e.g., smartphones, tablets, smart watches) via Bluetooth. In still further implementations, the communication unit 60 is configured to communicate with any other device in the system 10 wirelessly via one or more of: Bluetooth (BT); BT low-energy (LE) audio; broadcast such as via synchronized unicast; a synchronized downmixed audio connection over BT or other wireless connection (also referred to as SimpleSync™, a proprietary connection protocol from Bose Corporation, Framingham, MA, USA); and multiple transmission streams such as broadcast. In still further implementations, the communication unit 60 is configured to communicate with any other device in the system 10 via additional wireless communication approaches (e.g., Wi-Fi, RF) and/or a hard-wired connection, e.g., between any two or more devices.

In certain example implementations, additional devices 40 such as smart phones, smart watches, tablets, etc. in space 5 can include similar components (e.g., a processor 50 and communications unit 60) as the audio device 20. Further, those additional devices 40 can include additional components that may not necessarily be present at the audio device 30. Additional device(s) 40 can be configured to communicate with any device described herein.

Also shown in FIG. 1, one or more audio devices 20 and/or devices 40 can include an interface 110. In some cases, the interface 110 is a physical interface on the body of the device, although this is not necessary in all implementations. In certain cases, the interface 110 can include a touch screen, button, dial, slider, etc., that is configured to control one or more attributes of the audio device 20 (or devices 40) in a plurality of modes.

The audio device 20 can be configured to output audio from an audio source. In some cases, the audio source can include an audio gateway device such as device 40. In additional cases, the audio device 20 can be configured to output audio from an audio source via a network, cellular, and/or cloud-based connection, e.g., via a streaming music service, an internet radio station, a stored audio file library, etc. In various implementations, the audio device 20 can be referred to as a “smart” device that has network and/or cellular connectivity, and in certain cases, operate or otherwise execute virtual personal assistant (VPA) functions.

As described herein, the audio device 20 and/or the device 40 can be referred to as an audio capture device. That is, the audio device 20 and/or device 40 can include a microphone 80 that is configured to capture audio from the space 5, e.g., a voice command from a user in the space 5. In certain cases, the microphone 80 is integrated in the audio device 20 and/or device 40, and/or is a separate component coupled with the processor 50, e.g., a microphone accessory or accessory device including a microphone. In any case, one or both of the audio device 20 or device 40 can act as an audio capture device as described herein.

In particular cases, the processor(s) 50 may, for example, enable voice-based control of one or more actions using ML model 30. In certain cases, the ML model 30 is at least partially located at the audio device 20 and/or the device 40 in the space 5. For example, the ML model 30, or a version thereof, can be run or otherwise stored or operated locally at the audio device 20 and/or the device 40. In additional implementations, the ML model 30 is stored, operated, updated, or otherwise managed in a remote location 200, such as a centralized or distributed computer network or a cloud-based computer network or system. In particular implementations, the ML model 30 is periodically updated in the remote location 200, e.g., with training and/or refinement data. In certain cases, the ML model 30 is configured to be run at the remote location 200. In additional cases, a distinct, local version of the ML model 30 is configured to be stored and/or run at the audio device 20 and/or device 40.

In various implementations, processor(s) 50 in audio device 20 and/or device 40 include a (voice) routing control module which can include software and/or hardware for performing control processes described herein. For example, processor(s) 50 can include a voice routing control module in the form of a software stack having instructions for adjusting the attribute(s) of the audio device based on interaction with the ML model 30 according to any implementation described herein.

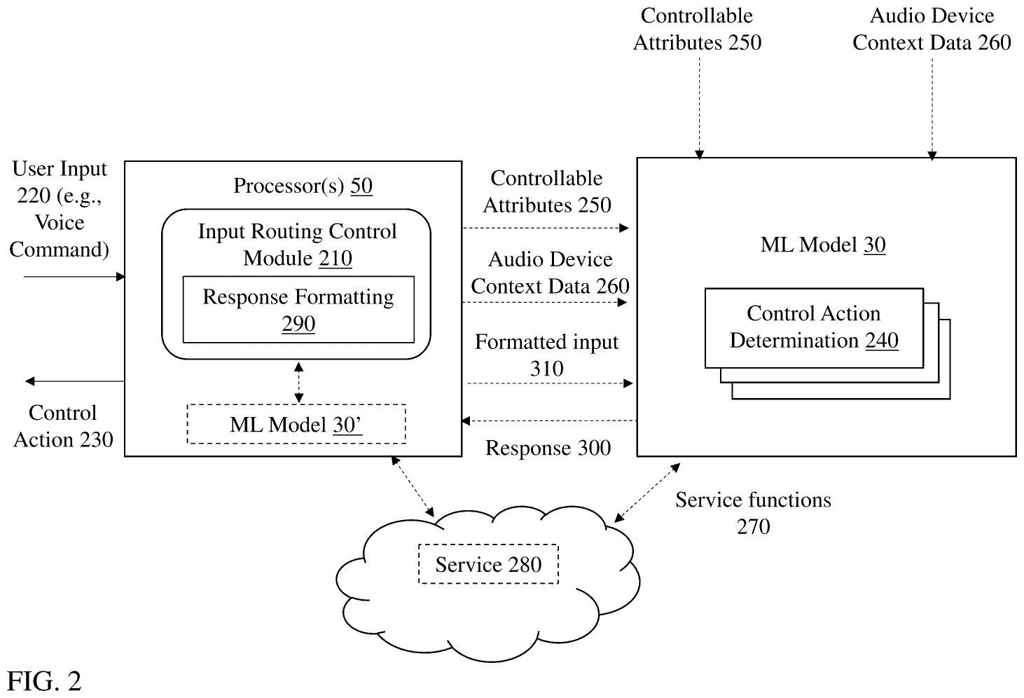

FIG. 2 is a schematic data flow diagram illustrating interaction of the processor 50 including a user input (e.g., voice) routing control module 210 that interfaces with the ML model 30 to determine a control action for at least one attribute of an audio device. In particular implementations, the ML model 30 includes an artificial intelligence engine that includes one or more neural networks, e.g., advanced neural networks (ANNs). In one example, the neural network(s) include a temporal convolutional network (TCN) and/or a convolutional long short term memory (ConvLSTM) network. In particular implementations, the ML model 30 includes a large language model (LLM) and/or a large action model (LAM) that is configured to determine a control action for one or more attributes of the audio device 20 based on user input, e.g., a voice input. In particular cases, the ML model 30 includes one or more models with a set of non-linear pathways defined as sequences of steps between distinct sets of parameters. In particular cases, the LLM and/or LAM differs from a database used by conventional virtual personal assistants, in that those conventional database systems require natural language (NL) inputs and training to infer a user's intent and decide on a response. As noted herein, various implementations of the ML model 30 and related approaches of the processor 50 do not require a NL input to infer intent and select a response. Further, conventional virtual personal assistants require a wake word to process the NL input. In contrast, the ML model 30 and processes performed by the processor 50 do not require a wake word to process a user input and provide a response/action.

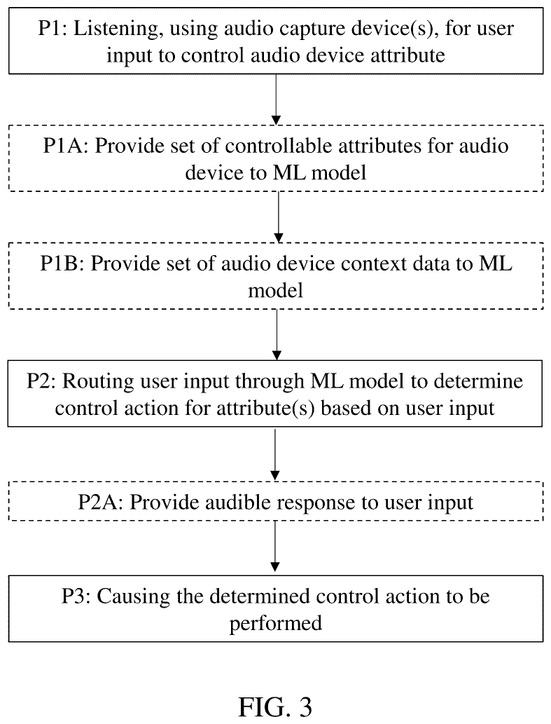

With continuing reference to FIG. 2, and additional reference to the process flow diagram in FIG. 3, approaches according to various implementations can include.

P1: listening, using an audio capture device (e.g., audio device 20 and/or device 40), for user input 220 to control at least one attribute of the audio device 20. As described herein, in certain cases, the audio device 20 is separate from the audio capture device, e.g., where the device 40 is the audio capture device. In other cases, the audio device 20 and the audio capture device are commonly housed, for example, as a single device.

In certain implementations, the audio capture device 20, 40 performs the listening without requiring a wake word. For example, the audio capture device 20, 40 can be in a default listening mode for user input to control the attribute(s) of the audio device 20. In additional implementations, the audio capture device 20, 40 detects a wake word (e.g., “Hey, Assistant”) prior to receiving the user input. In some aspects, the audio capture device 20, 40 performs the listening after detecting a user command. In particular examples, the user input 220 (or, user input command) includes at least one of, a wake word (e.g., detected via microphone(s) 80), a button press (e.g., as detected via interface 110), or a user interface actuation (e.g., as detected via interface 110).

In certain implementations, the user input 220 relates to controlling one or more attributes of a plurality of audio devices 20, 20A, 20B, etc. that include the audio device 20. In some examples, the attributes include coordinating playback, volume level, channel selection, or grouping of additional audio devices 20A, 20B, etc. As noted herein, additional audio devices 20A, 20B, etc., can be connected with or otherwise communicate with audio device 20, and can perform coordinated functions in certain implementations. Additional examples of multi-device controls are described, e.g., in U.S. patents application Ser. No. 18/387,144 (“Audio System Control Device”, filed Nov. 6, 2023) and Ser. No. 18/385,997 (“Dynamic Portable Speaker Grouping”, filed Nov. 1, 2023), each of which is incorporated by reference in its entirety.

Returning to FIGS. 2 and 3, process P2 can include routing (using input routing control module 210) the user input 220 through the ML model 30 to determine a control action (e.g., as control action instructions) 230 for the attribute(s). In particular cases, the ML model 30 includes a control action determination module 240 that is configured to determine the control action 230 for the audio device 20 based on the user input 220. In particular cases, the control action determination module 240 is configured to determine a control action 230 based on controllable attributes 250 and/or audio device context data 260, as described herein.

In particular examples, as illustrated in phantom in FIG. 2 as optional, the processor 50 or another device (e.g., audio device 20 and/or device 40) provides a set of controllable attributes 250 for the audio device 20 to the ML model 30. In certain cases, the set of controllable attributes 250 are provided to the ML model 30 with the user input 220, as illustrated in phantom as process P1A in FIG. 3. In other implementations, the controllable attributes 250 for the audio device 20 are provided to the ML model 30 prior to listening for the user input in process P1. In certain cases, the controllable attributes 250 are defined in terms of an application programming interface (API), e.g., JSON.

In certain examples, the process of routing the user input 220 through the ML model 30 includes defining a format of a response 300 from the ML model 30, e.g., using a response formatting module 290. In certain implementations, the response formatting module 290 converts the user input 220 into a formatted user input 310 that includes the context of the user input 220 along with format characteristics of the response 300. In one example, the format includes an object-based format such as JSON. In particular cases, the formatted user input 310 includes one or more keys for indicating a response 300 based on one or more decision layers. For example, the formatted user input 310 can include at least three distinct sets of decision layer keys, which may correspond with distinct layers of the ML model 30, e.g., one or more layers in the control action determination model 240. In one example, the control action determination model 240 includes a plurality of layers corresponding with: i) top level decisions (action routing), ii) wearable audio device type controls (e.g., where audio device 20 is a wearable audio device), iii) speaker or out-loud audio device type controls (e.g., where audio device 20 is a speaker intended to provide out-loud audio), iv) system state changes, v) external API response selection controls (e.g., in selecting responses from a service 280), and/or vi) text summarizer controls.

In one example, action routing (i) can include JSON responses with keys such as “Action”, “Data”, “FriendlyResponse”, etc. For example, Actions can include audio related controls, music related controls, movement of audio devices 20 (e.g., within space 5 or into/out of space 5), changing the state of a group of audio devices 20, and a No Match action. In certain cases, a No Match action is associated with a FriendlyResponse that includes a follow-up query such as a voice assistant-based question or request for information. A Data key can indicate a string of tasks as being completed.

In another example, a wearable audio device type control (ii) and/or a speaker type control (iii) can include similar response key categories such as “Action”, “Data”, “FriendlyResponse”, and can include a formatting requirement such as requiring that all JSON keys are included in the response 300. Further, the controls (ii) and/or (iii) can include a volume range identifier (e.g., from 0 to 100). A Data response can include replacing any X, Y, or Z found in an action and creating a list in the order of X, Y, then Z. A FriendlyResponse can include a brief description of the action being taken. Actions can include one or more of: play, pause, next track, previous track, restart track, repeat off, repeat track, repeat context, toggle shuffle, play on audio device X, play on all speakers, improve audio quality, speaker capabilities, battery level, grouping, add audio device X to group, remove audio device X from group, change in location of audio device X, like a song/track/stream, volume up, volume down, volume up by X, volume down by X, set volume to X, mute, unmute, get current track, play a playlist, search for or play a playlist, song, or music by an artist, add a song to a queue, search for lost audio devices, toggle immersion mode, toggle noise cancelation mode, toggle aware mode, move music in space (spatial audio controls), device setup instruction, speaker placement guidance, set EQ to match activity or audio source features, etc.

In a further example, a system state change control (iv) can include keys such as: {FriendlyResponse: String, Action: [Action1, Action 2], Grouped: [GroupedSpeaker1, GroupedSpeaker2], Rooms: {[RoomName]: [Speaker1, Speaker2], RoomName2: [Speaker3, Speaker4]}. In particular cases, the formatted input 310 requests the response 300 in JSON format according to the keys. In these cases, the formatted input 310 requests a response 300 indicating that one or more of the following in terms of speaker state: change in audio device group status, movement of audio device location, current system state, or response to message unrelated to grouping. In these examples, the formatted input 310 requests the response 300 to only refer to the audio device(s) 20 by the name found in the JSON formatted input 310.

In another example, a formatted input 310 including an external API response selection (v) includes a search key with a list of strings associated with one or more services 280, e.g., internet radio services, streaming services, audio content storage services, etc. This formatted input 310 can request the response 300 as a best match to one of the strings in the key.

In another example, the text summarizer controls (vi) include a formatted input 310 that defines the response 300 as a FriendlyResponse in sentence or phrase form, based on the user input 220.

In particular implementations, the FriendlyResponse described herein can include an audible response such as a voice assistant response in sentence or phrase form. In particular cases, the FriendlyResponse includes an audible response intended to elicit a follow-up user input 220, e.g., to refine and/or adjust a subsequent user input 220 and corresponding response 300.

In some examples, the user input 220 is compared to the controllable attributes 250 (e.g., a controllable attribute group) by the control action determination model 240, and if a match exists, a positive response is provided with an audible response related to the control action 230. In particular cases, controllable attributes 250 are separated into distinct groups or segments. For example, a positive response can include a chime, ring, or other sound, a visual indicator such as a light or color change in a display (e.g., change to green), a vibro-tactile response such as a vibration, and/or a voice assistant response such as, “Adjusting control attribute X” or “Thank you for your input, adjusting control attribute Y now.” In further examples, if no match exists, a null or negative response is provided, which can take any of the forms of a positive response, and may include a distinct color (e.g., red), distinct chime or sound, or a voice assistant response such as, “No match found” or “Sorry, I cannot understand that command.” In certain cases, the null response is used to determine which controllable attribute is desired to be modified. For example, by separating controllable attributes into groups or segments, null responses for particular groups or segments can aid in identifying the intended attribute, e.g., increasing the accuracy of the response. In such cases, null responses can be used to identify unintended attributes and refine the user's subsequent responses to enhance the chances of identifying the indented attribute.

In some implementations, as shown optionally in process P1B in FIG. 3, the method can further include providing a set of audio device context data 260 to the ML model 30 for use in determining the control action 230 for the at least one attribute 250. In some cases, the audio device context data 260 can include: usage data about the audio device 20, device state data (e.g., on, outputting audio, sleep mode, listening mode, paired with X, etc.) about the audio device 20, data about the known or likely user (e.g., based on proximity of a user device 40 such as smart phone to the audio device 20), user profile data about a user assigned to the audio device 20, data about location of the audio device 20 (e.g., in the kitchen), data about the type of audio device 20 (e.g., soundbar v. portable audio device v. headphones), time of day, prior and/or last-paired device data for a device paired to the audio device 20, etc. In certain examples, context data 260 can be provided to the ML model 30 with the user input (e.g., with process P1) or ahead of time (e.g., prior to process P1).

In particular cases, a control action 230 can include a change in an attribute 250 of the audio device 20 and/or maintaining an attribute 250 of the audio device 20. In particular examples, controlling attributes 250 of the audio device 20 can include controlling functions of the audio device 20 such as one or more of, transport control, volume of audio output, active noise reduction (ANR), audio device grouping, equalization of audio output, spatial audio controls (e.g., motion versus still, or object-based audio controls), transparency mode (e.g., on a wearable audio device), or channel playback (e.g., stereo, left/right, coordinating channels with another speaker, and/or party mode).

In further aspects, as noted herein, the user input 220 can be used to control functions 270 of a service 280 utilized by the audio device 20. For example, a service 280 can include a network and/or cloud-based music or audio content service such as an internet radio service. In certain cases, the user input 220 can be used to control functions 270 of the service 280, which in some cases, enables control of at least one of, a song or a track, an artist, a playlist, or a content channel.

In various implementations, as described herein the ML model 30 need not have been pre-trained with the user input 220 to determine the control action 230 for the at least one attribute 250 of the audio device 20, or to determine the service function 270 for the service 280. In various examples, determining the control action 230 includes selecting at least one attribute 250 of the audio device 20 based on inferred intent from the user input 220. That is, in various implementations the ML model 30 (in particular, control action determination model 240) includes at least one inference layer that is configured to infer the intent from a user command, e.g., an input 220. In certain cases, the inference layer(s) apply a nested selection approach to infer intent from the input 220.

In some aspects, the nested selection approach includes applying a local portion of the ML model run on the at least one audio capture device 40 or the audio device 20, e.g., ML model 30′, shown as local to processor(s) 50 in FIG. 2. The local portion 30′ of the ML model can be used to determine the control action in various implementations. If the attribute(s) of the audio device 20 are not selected by applying the local portion of the ML model 30′, the approach can further include applying an off-device portion of the ML model 30 to determine the control action, e.g., as described with respect to process P2. In certain of these cases the off-device portion of the ML model 30 is run on a smart device other than the audio capture device 20, 40 and/or a cloud-based or network-based system. In some examples, the nested selection approach includes evaluating the inferred intent relative to control functions of the audio device 20 prior to control functions of a service (e.g., service 280) utilized by the audio device 20. In some examples, the control functions of the audio device 20 include on-device functions or grouping functions. In particular aspects, control functions of the audio device enable control of at least one of, transport control, volume, active noise reduction (ANR), audio device grouping, equalization, spatial audio controls (e.g., motion versus still), transparency mode, or channel playback (e.g., stereo, left/right, coordinating channels with another speaker, and/or party mode). In certain aspects, the service 280 includes an audio streaming service or an internet radio service. In further aspects, control functions of the service 280 utilized by the audio device 20 enable control of at least one of, a song or a track, an artist, a playlist, or a content channel. In this approach, local functions controlled at the audio device 20 can be evaluated prior to functions controlled by a remote service such as service 280, which can provide certain benefits, e.g., reduced latency, reduced power/battery usage, and/or greater efficiency in executing commands.

In particular cases, the ML model 30′ run at the audio capture device 20, 40 and/or other device with processor 50 can be referred to as function-limited, or including a function-limited operational mode. In certain cases, the processor 50 is configured, in response to detecting a threshold latency in network communication, to run the ML model 30′ in the function-limited operational mode on the device(s) 20, 40 to improve the efficiency in the response to the user input 220. For example, the processor 50 can be configured to monitor network communication latency, and in response to the detected latency satisfying a latency threshold, run the function-limited ML model 30′ locally to determine the intended control action for the audio device 20.

In still further implementations, the function-limited ML model 30′ can be run as a default if user login credentials are not provided or are otherwise not authenticated for a service 280. In such cases, the function-limited ML model 30′ can also be selected according to user profile settings and/or device setup. For example, if a user sets up the audio device 20 without providing credentials for a service 280, the processor 50 can be configured to default to ML model 30′ in future uses, and/or provide a prompt to enter the credentials for service 280 in a subsequent use.

Returning to FIG. 3, after the control action is determined and response 300 is provided, the processor 50 is configured to cause the determined control action 230 to be performed (process P3). As noted herein, control actions 230 can include a change in the attribute 250 and/or maintaining of the attribute 250 identified from the input 220. In particular cases, the method further includes an optional process (P2A) including providing an audible response to the user input 220, e.g., a voice assistant response at the transducer(s) at the audio device 20 and/or device 40 (or another connected audio device 20 in space 5). For example, as noted herein, the audible response can include a natural language response including a query for an additional user input. In certain examples, the query includes a natural language based conversational response, such as from a virtual personal assistant, chatbot, or large language model.

As noted herein, in contrast to conventional approaches and systems, various implementations include approaches and systems for controlling audio devices using voice commands and a machine learning (ML) model. In particular cases, user input detected at an audio capture device is routed through an ML model to determine a control action for at least one attribute of the audio device, and based on processing by the ML model, the control action is performed. In various examples, the ML model needs not be pre-trained with the user input to determine the control action for the attribute. The ML model differs from a database used by conventional virtual personal assistants, in that those conventional database systems require natural language (NL) inputs and training to infer a user's intent and decide on a response. As noted herein, various implementations include providing response formatting information to the ML model to elicit a response that addresses the user input. Response formatting performed by the processor can obviate the need for a model that is trained with user inputs, and/or enhance the efficiency and/or accuracy of the decision-making process by the ML model. In any case, the approaches described according to various implementations have the technical effect of enhancing the efficiency and/or accuracy of control action selection for an audio device or a group of audio devices.

The above description provides embodiments that are compatible with BLUETOOTH SPECIFICATION Version 5.2 [Vol 0], 31 Dec. 2019, as well as any previous version(s), e.g., version 4.x and 5.x devices. Additionally, the connection techniques described herein could be used for Bluetooth LE Audio, such as to help establish a unicast connection. Further, it should be understood that the approach is equally applicable to other wireless protocols (e.g., non-Bluetooth, future versions of Bluetooth, and so forth) in which communication channels are selectively established between pairs of stations.

In some implementations, the host-based elements of the approach are implemented in a software module (e.g., an “App”) that is downloaded and installed on the source/host (e.g., a “smartphone”), in order to provide the controlled audio output aspects according to the approaches described above. In particular cases, functions such as input routing control can be controlled by a centralized interface command, e.g., a command at an interface on one of the audio devices, e.g., audio device(s) 20, 20A, 20B, etc.

While the above describes a particular order of operations performed by certain implementations of the invention, it should be understood that such order is illustrative, as alternative embodiments may perform the operations in a different order, combine certain operations, overlap certain operations, or the like. References in the specification to a given embodiment indicate that the embodiment described may include a particular feature, structure, or characteristic, but every embodiment may not necessarily include the particular feature, structure, or characteristic.

The functionality described herein, or portions thereof, and its various modifications (hereinafter “the functions”) can be implemented, at least in part, via a computer program product, e.g., a computer program tangibly embodied in an information carrier, such as one or more non-transitory machine-readable media, for execution by, or to control the operation of, one or more data processing apparatus, e.g., a programmable processor, a computer, multiple computers, and/or programmable logic components.

A computer program can be written in any form of programming language, including compiled or interpreted languages, and it can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a network.

Actions associated with implementing all or part of the functions can be performed by one or more programmable processors executing one or more computer programs to perform the functions of the calibration process. All or part of the functions can be implemented as, special purpose logic circuitry, e.g., an FPGA and/or an ASIC (application-specific integrated circuit). Processors suitable for the execution of a computer program include, by way of example, both general and special purpose microprocessors, and any one or more processors of any kind of digital computer. Generally, a processor will receive instructions and data from a read-only memory or a random access memory or both. Components of a computer include a processor for executing instructions and one or more memory devices for storing instructions and data.

In various implementations, unless otherwise noted, electronic components described as being “coupled” can be linked via conventional hard-wired and/or wireless means such that these electronic components can communicate data with one another. Additionally, sub-components within a given component can be considered to be linked via conventional pathways, which may not necessarily be illustrated.

The term “approximately” as used with respect to values herein can allot for a nominal variation from absolute values, e.g., of several percent or less. Where the term “comprising” is used in the present description and claims, it does not exclude other elements or operations. The term “based on” (as in “A is based on B”) is used to indicate any of its ordinary meanings, including the cases (i) “based on at least” (e.g., “A is based on at least B”) and, if appropriate in the particular context, (ii) “equal to” (e.g., “A is equal to B”). Similarly, the term “in response to” is used to indicate any of its ordinary meanings, including “in response to at least.”

A number of implementations have been described. Nevertheless, it will be understood that additional modifications may be made without departing from the scope of the inventive concepts described herein, and, accordingly, other embodiments are within the scope of the following claims.

1-20 (canceled)

21. A method comprising:
listening, using at least one audio capture device, for user input to control at least one attribute of an audio device;
routing the user input through a machine learning (ML) model to determine a control action for the at least one attribute based on the user input; and
causing the determined control action to be performed,
wherein the ML model need not have been pre-trained with the user input to determine the control action for the at least one attribute of the audio device.

22. The method of claim 21, wherein the audio capture device performs the listening without requiring a wake word.

23. The method of claim 21, wherein the audio capture device performs the listening after detecting a user command.

24. The method of claim 21, wherein determining the control action includes selecting the at least one attribute of the audio device based on inferred intent from the user input.

25. The method of claim 24, wherein the inferred intent is determined based on a nested selection approach.

26. The method of claim 25, wherein the nested selection approach includes,
applying a local portion of the ML model run on the at least one audio capture device or the audio device to determine the control action, and
if the at least one attribute of the audio device is not selected by applying the local portion of the ML model, applying an off-device portion of the ML model to determine the control action.

27. The method of claim 25, wherein the nested selection approach includes evaluating the inferred intent relative to control functions of the audio device prior to control functions of a service utilized by the audio device, wherein,
control functions of the audio device enable control of at least one of, transport control, volume, active noise reduction (ANR), audio device grouping, equalization, spatial audio controls, transparency mode, or channel playback, and
control functions of the service utilized by the audio device enable control of at least one of, a song or a track, an artist, a playlist, or a content channel.

28. The method of claim 21, further comprising providing an audible response to the user input after determining the control action, wherein the audible response includes a natural language response including a query for an additional user input.

29. The method of claim 21, wherein the user input relates to controlling one or more attributes of a plurality of audio devices including the audio device.

30. The method of claim 21, further comprising providing a set of controllable attributes for the audio device to the ML model, wherein the set of controllable attributes is provided to the ML model: a) prior to the listening, and/or b) with the user input.

31. The method of claim 21, further comprising providing a set of audio device context data to the ML model for use in determining the control action for the at least one attribute.

32. The method of claim 21, wherein routing the user input through the ML model includes defining a format of a response from the ML model including the control action.

33. The method of claim 21, wherein the ML model is run on the at least one audio capture device or the audio device, wherein the ML model includes a function-limited operational mode, wherein in response to detecting a threshold latency in network communication, the method includes running the ML model in the function-limited operational mode on the at least one audio capture device or the audio device.

34. The method of claim 21, wherein the ML model is cloud-based.

35. The method of claim 21, wherein the ML model includes at least one of, a large language model (LLM) or a large action model (LAM).

36. An audio device, comprising:
an electro-acoustic transducer;
at least one microphone; and
a processor coupled with the electro-acoustic transducer and the at least one microphone, the processor programmed to:
listen, using the at least one microphone, for user input to control at least one attribute of the audio device;
rout the user input through a machine learning (ML) model to determine a control action for the at least one attribute based on the user input; and
cause the determined control action to be performed,
wherein the ML model need not have been pre-trained with the user input to determine the control action for the at least one attribute of the audio device.

37. The audio device of claim 36, wherein the at least one microphone performs the listening without requiring a wake word.

38. The audio device of claim 36, wherein the at least one microphone performs the listening after detecting a user command.

39. The audio device of claim 36, wherein determining the control action includes selecting the at least one attribute of the audio device based on inferred intent from the user command.

40. The audio device of claim 36, wherein the inferred intent is determined based on a nested selection approach.
